(19) United States
(12) Patent Application Publication
(10) Pub. No.: US 2008/0098146 A1
(43) Pub. Date: Apr. 24, 2008

(54) Interrupt hooking method for a computing apparatus

(76) Inventor: Jang-Ying Lee, Ta-Li City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/583,927

(22) Filed: Oct. 20, 2006

(51) Int. Cl. G06F 13/24; G06F 13/32

(52) U.S. Cl. 710/269

(57) ABSTRACT

An interrupt hooking method for a computing apparatus, which includes a processing device and an interrupt controller, includes the steps of: enabling the processing device to convert a hardware interrupt request (IRQ) number of a system control interrupt (SCI) into a predefined interrupt vector according to an operating mode of the interrupt controller; and enabling the processing device to modify a pointer in an interrupt descriptor table that corresponds to the predefined interrupt vector for directing to a corresponding interrupt handler of the application program. A computing apparatus, which includes the processing device that performs the interrupt hooking method, is also disclosed.

### BACKGROUND OF THE INVENTION

1. Field of the Invention

This invention relates to an interrupt hooking method for a computing apparatus, more particularly to an interrupt hooking method for a computing apparatus that permits servicing of a system control interrupt (SCI) by a customized interrupt handler.

2. Description of the Related Art

An advanced configuration and power management interface (ACPI) system control interrupt (SCI) is typically generated by an operating system (OS) of a computing apparatus. In U.S. Patent Application Publication No. 2005/0138256, however, there is disclosed a conventional method that permits generation of the ACPI SCI through a hotkey using an operating system visible interrupt.

Although the aforementioned conventional method achieves its intended purpose, the ACPI SCI can be serviced only by predefined interrupt handlers of the ACPI.

### SUMMARY OF THE INVENTION

Therefore, the object of the present invention is to provide an interrupt hooking method that can overcome the aforesaid drawback of the prior art.

According to one aspect of the present invention, an interrupt hooking method for a computing apparatus, which includes a processing device and an interrupt controller, comprises the steps of:

a) through an application program, which is launched by the processing device, enabling the processing device to convert a hardware interrupt request (IRQ) number of a system control interrupt (SCI) into a predefined interrupt vector according to an operating mode of the interrupt controller; and

b) through the application program, enabling the processing device to modify a pointer in an interrupt descriptor table, which points to locations of interrupt handlers, that corresponds to the predefined interrupt vector obtained in step a) for directing to a corresponding interrupt handler of the application program.

According to another aspect of the present invention, a computing apparatus comprises a processing device, and an interrupt controller that is coupled to the processing device. The processing device has an interrupt descriptor table for pointing to locations of interrupt handlers, and is configured to launch an application program. The processing device is configured by the application program to convert a hardware interrupt request (IRQ) number of a system control interrupt (SCI) into a predefined interrupt vector according to an operating mode of the interrupt controller, and to modify a pointer in the interrupt descriptor table that corresponds to the predefined interrupt vector for directing to a corresponding interrupt handler of the application program.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of the first preferred embodiment of a computing apparatus according to this invention;

FIG. 2 is a schematic view to illustrate the computing apparatus of the first embodiment including three advanced programmable interrupt controllers;

FIGS. 3A to 3E are flowcharts of the preferred embodiment of an interrupt hooking method for the computing apparatus of the first embodiment according to this invention; and

FIG. 4 is a schematic block diagram of the second preferred embodiment of a computing apparatus according to this invention.

### DETAILED DESCRIPTION OF THE PREFERRED EMBODIMENTS

Before the present invention is described in greater detail, it should be noted that like elements are denoted by the same reference numerals throughout the disclosure.

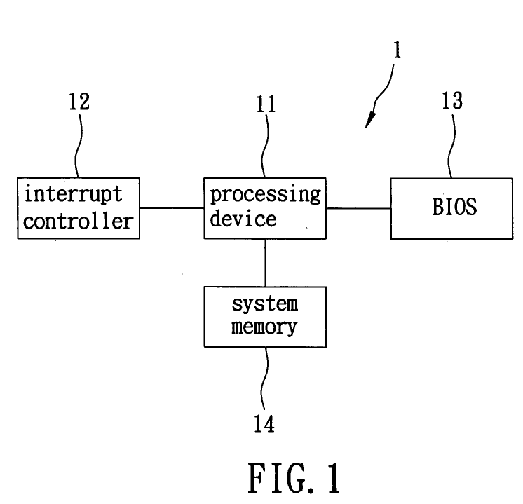

Referring to FIG. 1, the first preferred embodiment of a computing apparatus 1 according to this invention includes a processing device 11 and an interrupt controller 12.

In this embodiment, the computing apparatus 1 supports the IA32 platform Intel architecture, and uses a power management, which complies with an Advanced Configuration and Power Management Interface (ACPI). In an alternative embodiment, the computing apparatus 1 supports the IA64 Intel architecture.

The processing device 11 of the computing apparatus 1 is configured to launch an application program, and has an interrupt descriptor table (IDT) that includes two hundred and fifty-six descriptors, each of which includes a pointer that points to a location of a respective one of operating system interrupt handlers.

The interrupt controller 12 is coupled to the processing device 11 and has an operating mode. In this embodiment, the operating mode of the interrupt controller 12 may be one of a programmable interrupt controller (PIC) operating mode and an advanced programmable interrupt controller (APIC) operating mode.

The application program includes an interrupt hooking table, and an interrupt handler, which is also known as an interrupt service routine (ISR). In this embodiment, the interrupt hooking table of the application program includes an interrupt event that corresponds to the interrupt handler of the application program, and a plurality of entries, one of which records a relation between the interrupt event and the corresponding interrupt handler of the application program.

The processing device 11 is configured by the application program to convert a hardware interrupt request (IRQ) number, which is also known as a global system interrupt (GSINT) number, of a system control interrupt (SCI) into a predefined interrupt vector according to the operating mode of the interrupt controller 12, and to modify the pointer in one of the descriptors of the interrupt descriptor table that corresponds to the predefined interrupt vector for directing to a corresponding interrupt handler of the application program, in a manner that will be described in greater detail hereinafter.

The computing apparatus 1 further includes a basic input output system (BIOS) 13 that is coupled to the processing device 11, and that has an Advanced Configuration and Power Management Interface (ACPI) table, specifically, the fixed ACPI description table (FADT), from which the IRQ number of the SCI is obtained.

The IRQ number is converted into the predefined interrupt vector according to an operating system when the operating mode of the interrupt controller 12 is the PIC operating mode. That is, when the operating system is a disk operating system (DOS), the processing device 11 converts the IRQ number into the predefined interrupt vector using a first conversion algorithm. It is noted that, in DOS, IRQ numbers 0 through 7 correspond to predefined interrupt vectors 8h through Fh, respectively, and IRQ numbers 8 through 15 correspond to predefined interrupt vectors 70h through 77h, respectively. On the other hand, when the operating system is a windows operating system (OS), the processing device 11 converts the IRQ number into the predefined interrupt vector using a second conversion algorithm. It is noted that, in windows OS, IRQ numbers 0 to 15 correspond to predefined interrupt vectors 30h to 3Fh, respectively.

On the other hand, the IRQ number is converted into the predefined interrupt vector according to the ACPI table and register information in a maximum redirection entry register of the interrupt controller 12 when the operating mode of the interrupt controller 12 is the APIC operating mode. That is, the processing device 11 first obtains a GSINT base from the ACPI table and a number of interrupt inputs of the interrupt controller 12 from the maximum redirection entry register of the interrupt controller 12. Then, the processing device 11 converts the IRQ number into the predefined interrupt vector according to the GSINT base and the number of interrupt inputs of the interrupt controller 12, through an I/O redirection table (IOREDTBL) of the interrupt controller 12. It is noted that the IOREDTBL has twenty-four registers (IOREDTBL0 through IOREDTBL23), one of which includes the predefined interrupt vector.

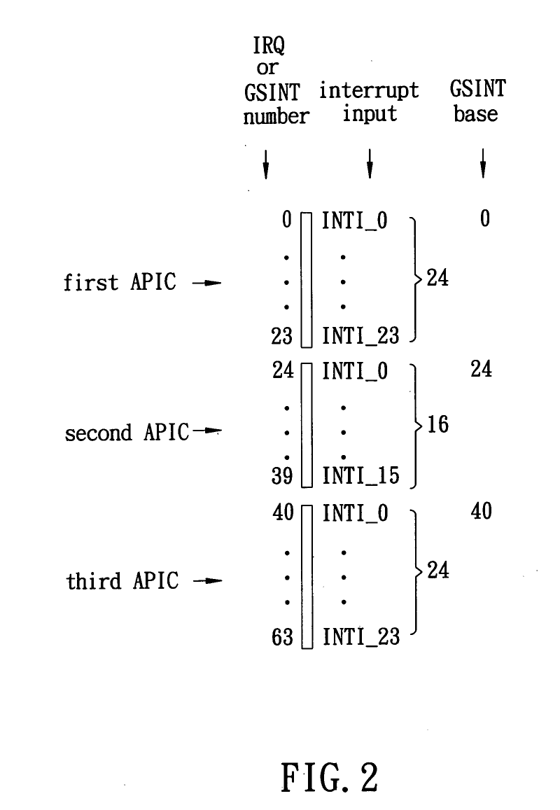

As an example, with further reference to FIG. 2, it is assumed that the computing apparatus 1 includes three of the APIC, namely first APIC, second APIC and third APIC. Typically, an APIC can support a maximum of twenty-four interrupt inputs. It is also assumed that the first, second and third APICs are implemented to support twenty-four, sixteen and twenty-four interrupt inputs, respectively. The GSINT bases that can be obtained from the FADT table are, therefore, 0, 24, and 40, and the numbers of interrupt inputs that can obtained from the maximum redirection entry register of the APIC are, therefore, 24, 16, and 24. The IRQ number can then be converted into the predefined interrupt vector by looking up the IOREDTBL referred by one of the obtained GSINT bases and one of the obtained numbers of the interrupt inputs.

It is noted that the computing apparatus 1 further includes a system memory 14 that is coupled to the processing device 11.

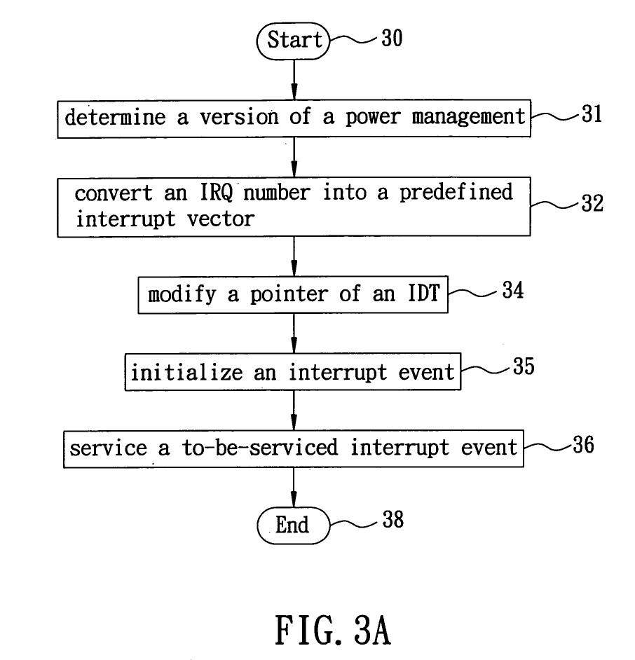

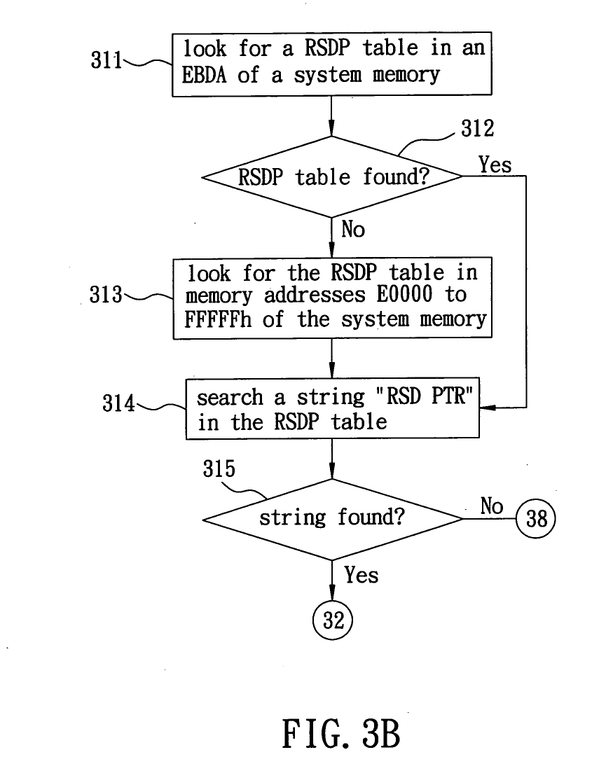

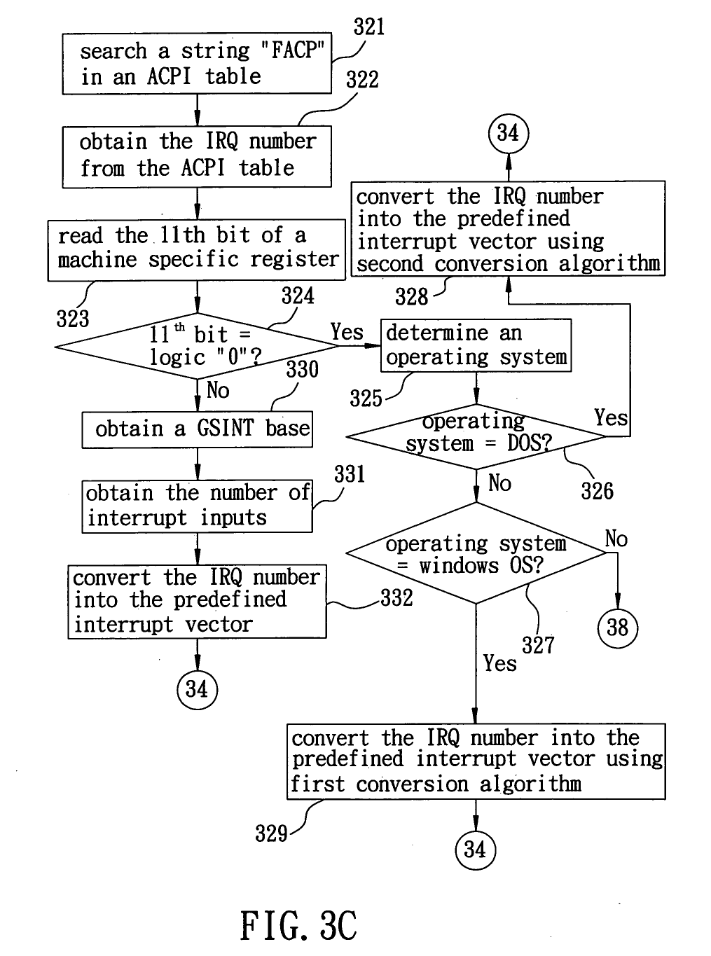

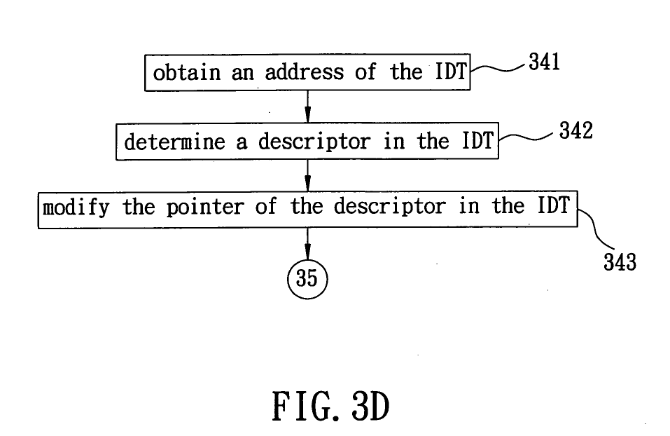

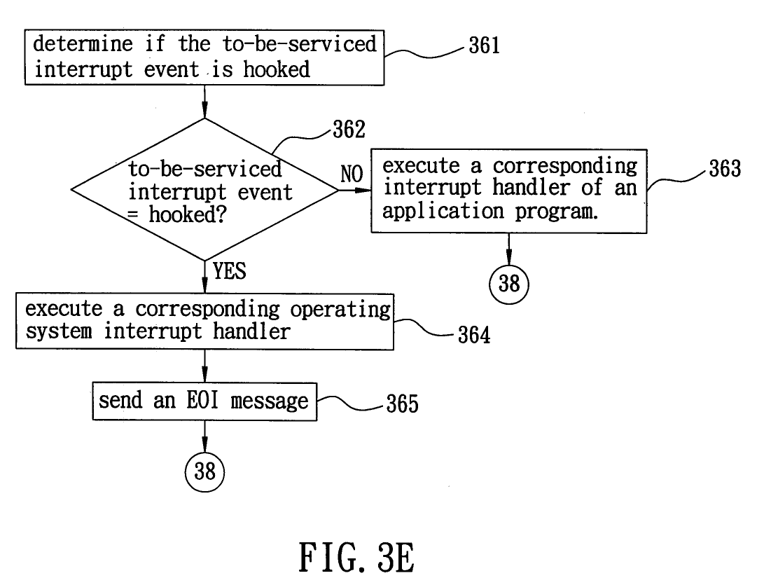

The preferred embodiment of an interrupt hooking method for the aforementioned computing apparatus 1 according to this invention includes the steps shown in FIG. 3A.

In step 31, through the application program, the processing device 11 determines a version of the power management used by the computing apparatus 1.

In this embodiment, step 31 includes the sub-steps shown in FIG. 3B:

Sub-step 311: the processing device 11 looks for a root system description pointer (RSDP) table in an extended BIOS data area (EBDA) of the system memory 14 of the computing apparatus 1.

Sub-step 312: when the processing device 11 finds the RSDP table in the EBDA of the system memory 14 of the computing apparatus 1, the flow proceeds to sub-step 314. Otherwise, when the processing device 11 does not find the RSDP table in the EBDA of the system memory 14 of the computing apparatus 1, the flow proceeds to sub-step 313.

Sub-step 313: the processing device 11 looks for the RSDP table in the memory addresses E0000 to FFFFFh of the system memory 14 of the computing apparatus 1. Thereafter, the flow proceeds to sub-step 314.

Sub-step 314: the processing device 11 searches a string “RSD PTR” in the RSDP table.

Sub-step 315: when the processing device 11 finds the string “RSD PTR” in the RSDP table, which indicates that the version of the power management used by the computing apparatus 1 complies with an ACPI 1.0 or later specification, the flow proceeds to step 32. Otherwise, when the processing device 11 does not find the string “RSD PTR” in the RSDP table, which indicates that the version of the power management used by the computing apparatus 1 does not comply with the ACPI 1.0 or later specification, the flow proceeds to step 38.

In step 32, through the application program, the processing device 11 converts the IRQ number of the SCI into the predefined interrupt vector according to an operating mode of the interrupt controller 12.

In this embodiment, step 32 includes the sub-steps shown in FIG. 3C:

Sub-step 321: the processing device 11 looks for the ACPI table, i.e., the FADT, by searching the string “FACP” in the BIOS 13 of the computing apparatus 1.

Sub-step 322: the processing device 11 obtains the IRQ number of the SCI from the ACPI table of the BIOS 13 of the computing apparatus 1.

Sub-step 323: the processing device 11 reads the 11^{th} bit of an IA32_APIC_BASE machine specific register thereof.

Sub-step 324: when the 11^{th} bit of the IA32_APIC_BASE machine specific register is a logic “0”, which indicates that the operating mode of the interrupt controller 12 is the PIC operating mode, the flow proceeds to sub-step 325. Otherwise, the 11^{th} bit of the IA32_APIC_BASE machine specific register is, therefore, a logic “1”, which indicates that the operating mode of the interrupt controller 12 is the APIC operating mode, and the flow proceeds to sub-step 330.

Sub-step 325: the processing device 11 determines the operating system.

Sub-step 326: when the operating system is determined in sub-step 325 to be the disk operating system (DOS), the flow proceeds to sub-step 328. Otherwise, the flow proceeds to sub-step 327.

Sub-step 327: when the operating system is determined in sub-step 325 to the windows OS, the flow proceeds to sub-step 329. Otherwise, the flow proceeds to step 38.

Sub-step 328: the processing device 11 converts the IRQ number of the SCI obtained in sub-step 322 into the predefined interrupt vector using the first conversion algorithm. Thereafter, the flow proceeds to step 34.

Sub-step 329, the processing device 11 converts the IRQ number of the SCI obtained in sub-step 322 into the predefined interrupt vector using the second conversion algorithm. Thereafter, the flow proceeds to step 34.

Sub-step 330: the processing device 11 obtains the GSINT base from the ACPI table of the BIOS 13 of the computing apparatus 1.

Sub-step 331: the processing device 11 obtains the number of interrupt inputs of the APIC from the maximum redirection entry register of the APIC.

Sub-step 332: the processing device 11 converts the IRQ number into the predefined interrupt vector according to the GSINT base obtained in sub-step 329 and the number of interrupt inputs of the interrupt controller 12 obtained in sub-step 330 through the IOREDTBL of the interrupt controller 12. Thereafter, the flow proceeds to step 34.

In step 34, through the application program, the processing device 11 modifies the pointer of the descriptor of the interrupt descriptor table (IDT) that corresponds to the predefined interrupt vector obtained in step 32 for directing to the corresponding interrupt handler of the application program.

In this embodiment, step 34 includes the sub-steps shown in FIG. 3D:

Sub-step 341: the processing device 11 obtains the address of the IDT by executing the command, SIDT (save IDT).

Sub-step 342: the processing device 11 determines the descriptor in the IDT that corresponds to the predefined interrupt vector obtained in step 32.

Sub-step 343: the processing device 11 modifies the pointer of the descriptor in the IDT. Thereafter, the flow proceeds to step 35.

In step 35, the processing device 11 initializes an interrupt event that corresponds to the IRQ number with reference to initialization information in the interrupt hooking table of the application program. Thereafter, the flow proceeds to step 36.

It is noted that the initialization information can be used to add, delete, enable or disable the interrupt events.

In step 36, in response to a to-be-serviced interrupt event, the processing device 11 services the to-be-serviced interrupt event.

In this embodiment, step 36 includes the sub-steps shown in FIG. 3E:

Sub-step 361: an interrupt processor of the processing device 11 determines if the to-be-serviced interrupt event is the interrupt event hooked by the application program by polling the entries of the interrupt hooking table.

Sub-step 362: when the to-be-serviced interrupt event is determined in sub-step 361 to be not the interrupt event hooked by the application program, the flow proceeds to sub-step 363. Otherwise, when the to-be-serviced interrupt event is determined in sub-step 361 to be the interrupt event hooked by the application program, the flow proceeds to step 364.

Sub-step 363: the interrupt processor of the processing device 11 executes a corresponding operating system interrupt handler. Thereafter, the flow proceeds to step 38.

Sub-step 364: the interrupt processor of the processing device 11 executes the corresponding interrupt handler of the application program.

Sub-step 365: the processing device 11 sends an end of interrupt (EOI) message to the interrupt controller 12 after servicing the to-be serviced interrupt event. Thereafter, the flow proceeds to step 38.

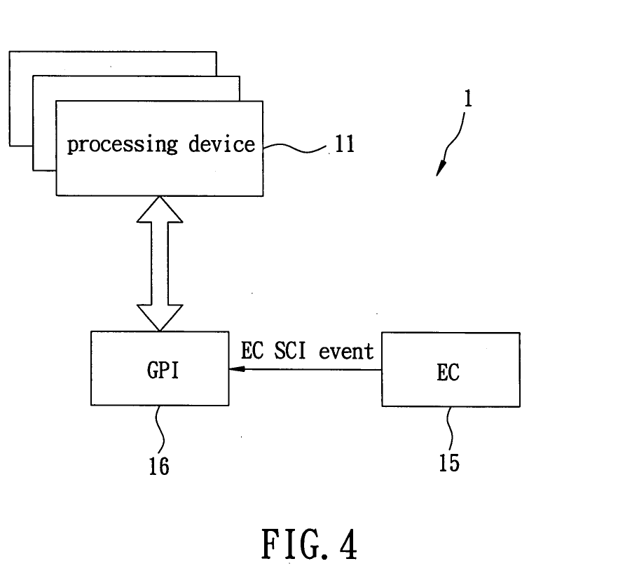

FIG. 4 illustrates the second preferred embodiment of a computing apparatus 1 according to this invention. When compared to the previous embodiment, the computing apparatus 1 is a notebook computer, and further includes a General Purpose Interface (GPI) 16 that is coupled the processing device 11, and an embedded controller (EC) 14 that is coupled to the GPI 16. In operation, when an EC interrupt event occurs, the EC 14 sends an EC SCI event to the processing device 11 through the GPI 16. In response to the EC interrupt event, the processing device 11, through the application program, executes an EC command to obtain an EC code to determine if the EC interrupt event is the interrupt event hooked by the application program. When the EC interrupt event is determined to be the interrupt event hooked by the application program, the EC interrupt event is serviced by the interrupt handler of the application program. On the other hand, when the EC interrupt event is determined to be not the interrupt event hooked by the application program, the EC interrupt event is serviced by an operating system power management (OSPM). In this case, the EC code is “pushed back” to a polling pool of the EC 14.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An interrupt hooking method for a computing apparatus that includes a processing device with an interrupt descriptor table for pointing to locations of interrupt handlers, and an interrupt controller, the processing device being configured to launch an application program, said interrupt hooking method comprising:
a) through the application program, enabling the processing device to convert a hardware interrupt request (IRQ) number of a system control interrupt (SCI) into a predefined interrupt vector according to an operating mode of the interrupt controller; and
b) through the application program, enabling the processing device to modify a pointer in the interrupt descriptor table that corresponds to the predefined interrupt vector obtained in step a) for directing to a corresponding interrupt handler of the application program.

2. The interrupt hooking method of claim 1, wherein, in step a), the IRQ number is obtained through the application program from a BIOS of the computing apparatus.

3. The interrupt hooking method of claim 1, wherein, in step a), the IRQ number is obtained through the application program from an Advanced Configuration and Power Management Interface (ACPI) table of a BIOS of the computing apparatus.

4. The interrupt hooking method of claim 1, further comprising, prior to step a), enabling the processing device to determine a version of a power management used by the computing apparatus through the application program, and
wherein steps a) and b) are performed only when the version of the power management complies with an Advanced Configuration and Power Management Interface (ACPI) specification.

5. The interrupt hooking method of claim 1, wherein the operating mode of the interrupt controller is one of a programmable interrupt controller (PIC) operating mode and an advanced programmable interrupt controller (APIC) operating mode.

6. The interrupt hooking method of claim 1, wherein, in step a), the IRQ number is converted into the predefined interrupt vector according to an operating system of the computing apparatus when the operating mode of the interrupt controller is a programmable interrupt controller (PIC) operating mode.

7. The interrupt hooking method of claim 6, wherein the operating system is one of a disk operating system and a windows operating system.

8. The interrupt hooking method of claim 1, wherein, in step a), the IRQ number is converted into the predefined interrupt vector according to an Advanced Configuration and Power Management Interface (ACPI) table of a BIOS of the computing apparatus and register information of the interrupt controller when the operating mode of the interrupt controller is an advanced programmable interrupt controller (APIC) operating mode.

9. The interrupt hooking method of claim 8, wherein, in step a), when the operating mode of the interrupt controller is the APIC operating mode, the processing device
obtains a GSINT base from the ACPI table,
obtains a number of interrupt inputs of the interrupt controller from a maximum redirection entry register of the interrupt controller, and
converts the IRQ number into the predefined interrupt vector according to the GSINT base and the number of interrupt inputs of the interrupt controller through an I/O redirection table of the interrupt controller.

10. The interrupt hooking method of claim 1, further comprising:
d) initializing an interrupt event that corresponds to the IRQ number with reference to initialization information in an interrupt hooking table of the application program, wherein the interrupt hooking table includes a plurality of entries, one of which records a relation between the interrupt event and the corresponding interrupt handler of the application program.

11. The interrupt hooking method of claim 10, wherein the initialization information can be used to add, delete, enable or disable the interrupt event.

12. The interrupt hooking method of claim 10, further comprising servicing a to-be-serviced interrupt event including
enabling the processing device to determine if the to-be-serviced interrupt event is the interrupt event hooked by the application program by polling the entries of the interrupt hooking table,
when the processing device determines that the to-be-serviced interrupt event is not the interrupt event hooked by the application program, enabling the processing device to execute a corresponding operating system interrupt handler, and
when the processing device determines that the to-be-serviced interrupt event is the interrupt event hooked by the application program, enabling the processing device to execute the corresponding interrupt handler of the application program and to send an end of interrupt (EOI) message to the interrupt controller after servicing the to-be serviced interrupt event.

13. A computing apparatus comprising a processing device with an interrupt descriptor table for pointing to locations of interrupt handlers, and an interrupt controller coupled to said processing device, said processing device being configured to launch an application program,
wherein said processing device is configured by said application program to convert a hardware interrupt request (IRQ) number of a system control interrupt (SCI) into a predefined interrupt vector according to an operating mode of said interrupt controller, and to modify a pointer in said interrupt descriptor table that corresponds to the predefined interrupt vector for directing to a corresponding interrupt handler of said application program.

14. The computing apparatus of claim 13, further comprising a BIOS from which the IRQ number is obtained.

15. The computing apparatus of claim 13, further comprising a BIOS with an Advanced Configuration and Power Management Interface (ACPI) table from which the IRQ number is obtained.

16. The computing apparatus of claim 13, further comprising an operating system, the IRQ number being converted into the predefined interrupt vector according to said operating system when the operating mode of said interrupt controller is a programmable interrupt controller (PIC) operating mode.

17. The computing apparatus of claim 16, wherein said operating system is one of a disk operating system and a windows operating system.

18. The computing apparatus of claim 13, further comprising a BIOS with an Advanced Configuration and Power Management Interface (ACPI) table, wherein the IRQ number is converted into the predefined interrupt vector according to said ACPI table and register information of said interrupt controller when the operating mode of said interrupt controller is an advanced programmable interrupt controller (APIC) operating mode.

19. The computing apparatus of claim 18, wherein, when the operating mode of said interrupt controller is the APIC operating mode, said processing device
obtains a GSINT base from said ACPI table,
obtains a number of interrupt inputs of said interrupt controller from a maximum redirection entry register of said interrupt controller, and
converts the IRQ number into the predefined interrupt vector according to the GSINT base and the number of interrupt inputs of said interrupt controller through an I/O redirection table of said interrupt controller.

20. A machine readable storage medium having instructions stored therein which when executed cause a processing device to perform a set of operations comprising:
a) converting a hardware interrupt request (IRQ) number of a system control interrupt (SCI) into a predefined interrupt vector according to an operating mode of an interrupt controller; and
b) modifying a pointer in an interrupt descriptor table that corresponds to the predefined interrupt vector obtained in step a) for directing to a corresponding interrupt handler of the stored instructions.
